(19) United States
(12) Patent Application Publication
(10) Pub. No.: US 2009/0234474 A1
(43) Pub. Date: Sep. 17, 2009

(54) Integrated FM/AM receiver, recorder and audio/video player for vehicles

(76) Inventors: Marilyn M. Steiner, Las Vegas, NV (US); Chris Steiner, Las Vegas, NV (US)

Correspondence Address: DAVID J. WILSON, 61 BELCHER CIRCLE, MILTON, MA, 02186, US

(21) Appl. No.: 12/075,691

(22) Filed: Mar. 13, 2008

(51) Int. Cl. G06F 17/00; G06F 17/30

(52) U.S. Cl. 700/94; 707/104.1; 707/E17.009

(57) ABSTRACT

This invention relates to a device that is sized to fit into a receptacle for a vehicle radio (e.g., a car radio) wherein said device comprises functions and utility hitherto not associated with a vehicle radio. The device of the present invention comprises, for example, a means for inputting (or receiving) radios signals (i.e., FM and/or AM radio signals) as well as input from other audio sources. Additionally, the device comprises means for inputting video files. The means of input may be any means known to those skilled in the art including, but not limited to, broadcast radio signals, MP3 players, cassette tapes, compact disks (CDs), minidisks (MDs), digital video disks (DVDs), wired input and wireless input. The device also has means for displaying video, data about stored files and a file system for organizing said files.

### BACKGROUND OF INVENTION

Today, many individuals have extensive audio and video collections. Furthermore, with the advent of new media for audio and video storage, users have many more options in which to transport their favorite songs, pictures and videos. However, and in spite of this, most persons listen to the radio in the automobile. The problem with radio is that often times a person may miss what is being said on the radio because they are concentrating on a driving situation or are distracted by other conversations or activity in the vehicle. Although this may seem only like an inconvenience in most situations, in actuality missing a portion of a broadcast may be crucial to determining the best route to take, for example, if the traffic or weather report is missed.

Additionally, with more media types available to today's consumer than ever before (e.g., CDs, mini disks, cassette tapes, MP3 and other electronic or digital formats), users must often choose to leave their favorite music at home for want of compatible device to play their music. Furthermore, people now have the option of bringing with them DVD videos useful, for example, to entertaining children on long trips. Also, users can now take their own videos with video recorders or camera phones. Some automobiles come with installed DVD players and after market systems are available for purchase, but both of these prior art solutions are not without problems of their own. For example, the purchaser often has little choice over the features available on a preinstalled system and must take what is available. After market systems do not install into the vehicle and must be strapped to the vehicle seats. Because of this drawback, they are also easily damaged or stolen. Also, these prior art players often do not allow for the transfer or playback of video from, for example, camera phones or other devices.

With so many options to today's driver and passengers, the organization of audio and video files can be a daunting task. In this regard, persons need to have a means for organizing and ordering media files in the vehicle's “radio.”

Thus, what is needed is a new type of “car radio” that eliminates these and other problems with the available prior art devices.

### SUMMARY OF INVENTION

In one aspect, the invention relates to a device that is sized to fit into a receptacle for a vehicle radio (e.g., a car radio) wherein said device comprises functions and utility hitherto not associated with a vehicle radio. The device of the present invention comprises, for example, a means for inputting (or receiving) radios signals (i.e., FM and/or AM radio signals) as well as input from other audio sources. Additionally, the device comprises means for inputting video files. The means of input may be any means known to those skilled in the art including, but not limited to, broadcast radio signals, MP3 players, cassette tapes, compact disks (CDs), minidisks (MDs), digital video disks (DVDs), wired input and wireless input (such as, for example, Bluetooth™ compatibility).

The device of the present invention also comprises means for storing files comprising audio and video data. The storage means may comprise, for example, a hard drive or other electronic storage means known to those skilled in the art. The capacity of the device may be limited by physical size limitations or by user desire or necessity. For example, a user that predominately stores audio files (as opposed to video files which tend to be larger than audio files) may prefer to have a device that has limited storage capacity if there were corresponding reduction in price. Users that only store data for short periods of time may also be satisfied with a device with smaller storage capacity. On the other hand, users that store much data or larger files for longer periods of time may prefer a device with larger storage capacities. In the context of the present invention, “digital data” and “electronic data” are synonymous and refer to data that has been digitized (as is known by those skilled in the art) or is storage electronically.

The device of the present invention also comprises means for playback of audio and video. Audio playback is through audio speakers usually positioned in the vehicle for optimal sound reproduction and video playback is through an integral LCD screen. The device may also comprise additional auxiliary screens on which playback can be seen once the signal is sent to the auxiliary screen with via a wired or wireless connection.

Further still, the device of the present invention may have Bluetooth™ wireless capability for connection with various wireless devices such a MP3 players, auxiliary LCD screens and the like.

In one aspect of the invention, the data recorded or stored in the device of the present invention is organized into a file system wherein said file system can be further organized by a user where the files can be organized by one or more of file size, file type, date of storage, date of original file generation, genera of audio or video file style and where said data can be manipulated by said user.

Expanding on the element of the present invention of the last paragraph, the device of the present invention also comprises a system of data storage and organization which can be visualize by the user on the LCD screen. The LCD screen, in one embodiment, may provide a graphical user interface (GUI) or may provide lists of data, either of which allow the data to be manipulated by the user. The LCD screen, in one embodiment, is touch sensitive thereby allowing the user to manipulate data by touching the screen. In another embodiment, icons, for example, may be dragged from one area on the screen to another area on the screen to organize and/or manipulate data. In another embodiment, the user may manipulate data by means of a wireless device. The wireless device may have cursor keys to manipulate data or a keyboard to enter letters, numbers of other symbols. The wireless device may be interfaced with the device of the present invention via, for example, Bluetooth™ wireless technology or similar. In another embodiment, the user would have to option of activating and controlling the device via voice commands. Such technology is known in the art and is used frequently, for example, in telephone answering systems, ATMs, etc. The storage and manipulation of data may be delayed after the user inputs the commands or the storage and manipulation of data may be performed by the device in real-time as the user provides the input. In other embodiment, the device of the present invention may be controlled via controls that have been incorporated into or on to the vehicle's steering wheel. In yet another embodiment, the device of the present invention is controlled by more than one of the means described above and below.

In still yet another embodiment, the device of the present invention is controlled via iDrive™ technology. In iDrive™ technology the functions most important for motoring and safety on the road have been moved to the direct vicinity of the driver. In iDrive™ technology all primary driving functions are in the area around the steering wheel, offering the driver more immediate access to key controls. Second level functions are controlled by conventional switches on the instrument panel. Many controls are operated with a single large, multifunction knob located in the console between the front seats. The control consists of a combination rotary and push button for selecting functions. Confirmation of the selected mode is displayed on a dash mounted or radio mounted screen. Users can change functions—from communications to climate control, navigation or entertainment—by pushing the console knob forward or back, or side-to-side. By twisting the knob, they can scroll through menus. And by clicking a button located in the middle of the knob, they can select functions.

“iDrive™” takes into account the fact that comfort, communication and driver assistance functions are, for some individuals, only rarely adjusted while driving. The operating unit in the center console gives the driver direct access to many other driving functions and information and a computer-type monitor is positioned directly within the driver's line of vision to the road ahead or on the radio device of the present invention. The large monitor in the center of the dashboard set within the radio device of the present invention displays all the information the driver needs as it pertains to the device of the present invention. The device of the present invention, in one embodiment, is positioned within the driver's field of vision, allowing it to be viewed while focusing attention on the road ahead. The third generation Universal Mobile Telecommunications System (UMTS) may also be used with the device of the present invention which would further enables the wireless services used by the iDrive™ compatible system of the present invention, with data transfer rates of about 2 Mbps or higher.

In other embodiments, the device of the present invention may provide navigational capability via, for example, GPS (global positioning satellite) systems. The navigational system would be displayed on the LCD screen of the device.

In a preferred embodiment, the user may record FM and/or AM broadcast signals off of the radio and on to the data storage means of the present invention for playback when desired. The device may include, in one embodiment, a “live-pause” feature that stops (or pauses) the broadcast from being heard but continues to record the broadcast on to the storage means. In another embodiment, the device may record one broadcast while simultaneously playing another broadcast. In yet another embodiment, the device may record a radio broadcast while playing another non-broadcast audio or video source (that is, it may record a radio broadcast while playing a CD, for example). Also, the device may be capable of receiving “on-demand” or “access anytime” broadcasts. With this technology the user may select at any time a prerecorded program (such as, for example, a special concert broadcast of a favorite band, a selection of a favorite song or album, a recorded radio simulcast of “60 Minutes” or a video broadcast) from a station or other supplier of these formats. The user may then pause, speed-up or rewind the broadcast at will. In this embodiment, the broadcast is not entirely stored on the users device (other than, perhaps, small portions of the broadcast positioned just before or after the portion being enjoyed) but continuously received form the supplier or received in packets of information. The size of the packets would depend on the technology employed by the supplier and other technical considerations know in the art.

In another embodiment of the present invention the device of the present invention displays a personalized greeting when the device is turned on. The greeting may be audio, video or a combination of both. The greeting may be changed by the user if the user so desires of the device may select from various personalized greeting programmed into the device or downloaded into the device by the user. Examples of such greeting may be “Hello,” “Good Morning” followed by the user's name or a video representation of a sunrise or of a flower opening.

The present invention also contemplates methods of use including, for example, a method of audio/video playback, storage and organization in a motorized vehicle, comprising: providing a device designed to be installed in the pre-sized radio receptacle of the motor vehicle, said device comprising a receiver for FM and AM radio signals, a CD/DVD player/recorder, optionally, one or more of a cassette tape player or minidisk player, an input for digital audio and video files, an LCD screen for visualizing video and visualizing audio/video file data and a means for storage of electronic data; wherein said means for the storage for electronic data can store digital audio and/or video data from one or more of the audio/video input sources including the FM radio signals, the AM radio signals, the CD/DVD player, the input for digital audio and video files and the optional cassette tape player or minidisk player, if present, and wherein said means for the storage of electronic data can record one form of audio and/or video data while acoustically and/or visually playing the same form or another form of audio and/or video data simultaneously or sequentially and wherein said audio or video can be played back at a time the user desires and wherein said means for one or more of storage of FM radio signals or AM radio signals includes a live-pause feature to selectively prevent portions of a broadcast to be selectively chosen for not being stored; wherein said recorded or stored data is organized into a file system and wherein said file system can be further organized by a user wherein said organization can be by one or more of file size, file type, date of storage, date of original file generation, genera of audio or video file style and wherein said data can be manipulated by said user; wherein said data organization and manipulation can be visualized on said LCD screen in real-time as user organizes and manipulates said electronic data; and wherein said device incorporates a means for generating a personal greeting to be displayed on said LCD screen or played on said device upon turning said device on.

In another embodiment, it is contemplated that device of the exemplary method above has an LCD screen that incorporates a touch-sensitive display.

In another embodiment, it is contemplated that the device of the present invention is PC (personnel computer) operating system capable thereby allowing integration with computer files and permitting internet capability of the device.

In yet another embodiment, it is contemplated that the audio or video files can be uploaded to an external device.

In still yet another embodiment, it is contemplated that the device can be preprogrammed to record signals from one or more of said FM or AM radio signals as a pre-determined time. It is also contemplated that the device can be used for receiving “on demand” programming thereby allowing one to receive or download specific programs over the airwaves or internet connection. In this way, a user could listen to a specific type of program (e.g., news or weather) when they wanted to nor needed to or listen to a specific program (e.g., a favorite radio program or specific broadcast) when it was convenient. In this way, a user could listen to a particular program in their car when on a long trip and not have to miss the program because the broadcast did not coincide with their travel plans.

In still yet another embodiment, it is contemplated that the LCD screen is selected from one or more of an integral display on the face of the device, a flip-down panel mounted on the face of the device or a panel that is pulled out from the device and folded down.

In still yet another embodiment, it is contemplated that the flip-down or pull out and fold-down screen is adjustable as to the angle at which the screen is positioned in relation to the front of the device.

In still yet another embodiment, it is contemplated that the information (for example, the name of the file, song or video, the size of the file, the artist, etc.) about said files stored within said device are provided within said files.

In still yet another embodiment, it is contemplated that the information about said files stored within said device are provided by the user through user input.

In still yet another embodiment, it is contemplated that the information provided by said user is delivered to said device by a wireless input device.

In still yet another embodiment, it is contemplated that the input source for said device is a camera phone, MP3 or similar digital audio player, a CD player, a DVD player, a video camera, etc.

In still yet another embodiment, it is contemplated that the device can convert analog input signals to a digital storage format. Such digital storage formats are known in the art.

In still yet another embodiment, it is contemplated that the features of the vehicle audio/video system of the present invention be incorporated in to a home or office-based system (i.e., any land based system that is not in a moving vehicle). In this regard, the system may be capable of being removed from the vehicle and inserted into a home or office-based receptacle thereby allowing the user to use one in multiple locations. In this way a user could continue enjoying the same programming or share favorite programs with other persons within the comfort of their home.

Other features and advantages of the invention will be apparent from the following description.

### BRIEF DESCRIPTION OF DRAWINGS

FIG. 1 shows one embodiment of the device of the present invention wherein the device has an integral LCD screen.

FIG. 2 shows one embodiment of the device wherein the device has a flip-down LCD screen. The screen is in the non-flipped-down position in this figure.

FIG. 3 shows one embodiment of the device wherein the device has the flip-down LCD screen in the flipped-down position.

FIG. 4 shows one embodiment of the present invention wherein the device has a pullout LCD screen. The screen is in the non-pulled out position in this figure.

FIG. 5 shows one embodiment of the present invention wherein the device has a pullout LCD screen in the pulled out position.

FIG. 6 shows one embodiment of the present invention wherein the device has a pullout LCD screen and a slot for inserting CDs and DVDs. One skilled in the art will realize that the other embodiments of the devices of the present invention as, for example, illustrated in the figures referred to above, may also include a slot of inserting and retrieving CDs and DVDs.

FIG. 7 shows one embodiment of a remote control that may be used with the audio/video system of the present invention.

### DETAILED DESCRIPTION OF PREFERRED EMBODIMENTS

The invention will now be described in detail with reference to a few preferred embodiments, as illustrated in accompanying drawings. In the following description, numerous specific details are set forth in order to provide a thorough understanding of the invention. However, it will be apparent to one skilled in the art that the invention may be practiced without some or all of these specific details. In other instances, well-known features and/or process steps have not been described in detail in order to not unnecessarily obscure the invention. The features and advantages of the invention may be better understood with reference to the drawings and discussions that follow.

While the invention has been described with respect to a limited number of embodiments, those skilled in the art, having benefit of this disclosure, will appreciate that other embodiments can be devised which do not depart from the scope of the invention as disclosed herein.

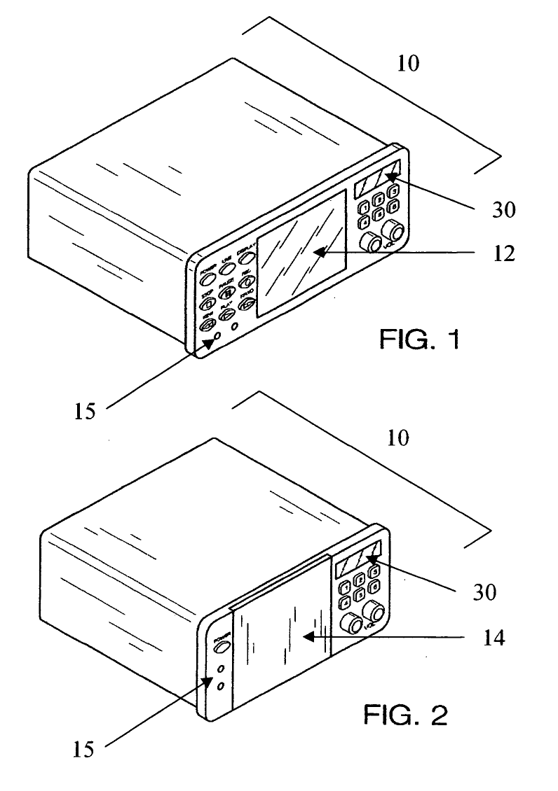

Turning first to FIG. 1, the device of the present invention 10 is shown in one embodiment wherein the LCD screen 12 is located on the face of the device. A second display window 30 is also shown for use with, for example, displaying the time, the station to which the unit is tuned into or brief messages indicating the function currently being performed by the unit (e.g., FF [fast forward], RW [rewind], PLAY, RECORD, etc.). Audio and video input ant output ports 15 are also visible on the lower left-hand edge of the face of the device. The other buttons and knobs on the face of the device may be designed to control the various features of the device such as, for example, selecting the function of the device (e.g., radio, CD, MP3, input or upload to the device, output or download from the device or record, playback fast forward and rewind).

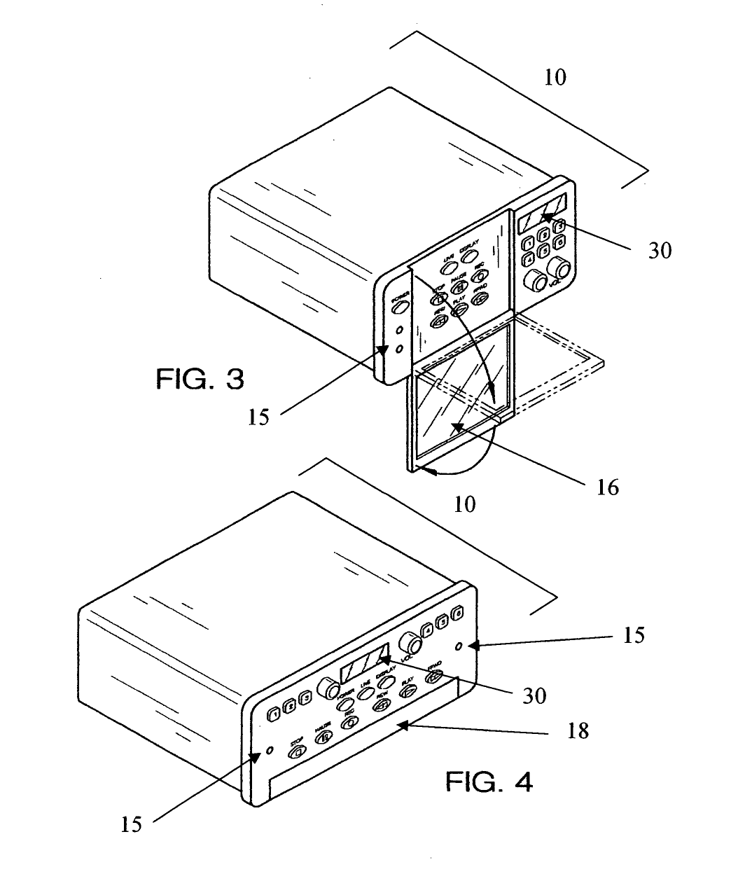

FIG. 2 shows a second embodiment of the present device 10 wherein the LCD screen is located on a flip-down panel 14 such that it is hidden from view and protected from damage when not in use and easily accessed when needed. FIG. 3 shows the same device with the screen flipped down and the LCD screen 16 visible. A multitude of control buttons suitable for controlling functions associated with the LCD screen may be located under the flip-down LCD screen, as illustrated.

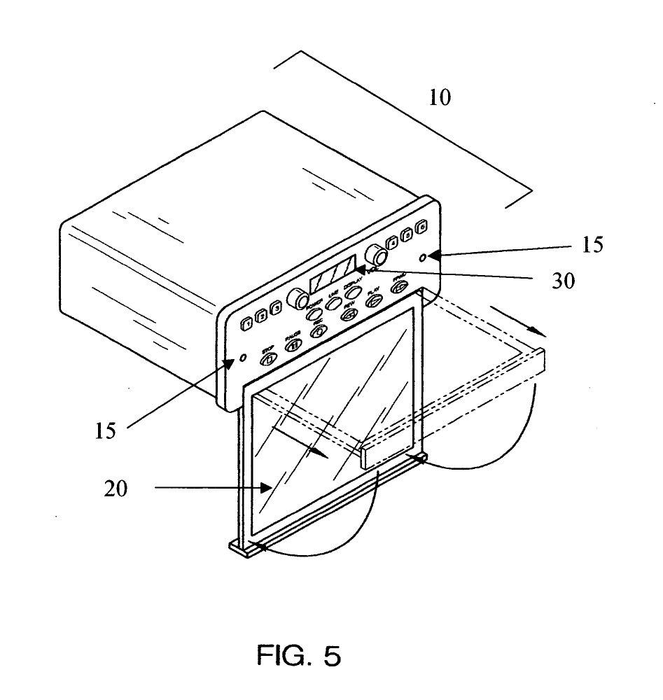

FIG. 4 shows yet another embodiment of the device of the present invention wherein the LCD screen is a pullout screen 18. FIG. 5 shows the screen pulled out and flipped down for viewing with the LCD screen 20 exposed. In both the flip-down and pullout versions of the device, the screens are designed to be positioned at an angle, if desired, for ease of viewing. Likewise, the screens, in one embodiment, may be rotated left and/or right by about 1-20 degrees to angle the screen towards the user. In these embodiments, the connection between the screen and main unit of the device would be located in or near the center of the edge of the screen that contacts the main unit. The screen would need to be centered or positioned at about zero degrees before being flipped up or pushed into the device after use.

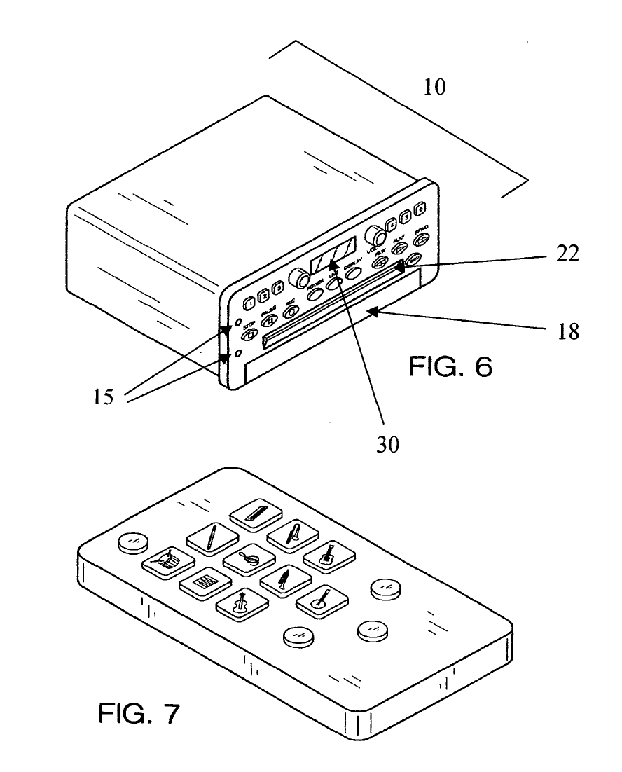

FIG. 6 shows yet another embodiment of the device wherein a CD/DVD slot 22 is visible. All embodiments of the present device may have a CD/DVD slot incorporated into the design if desired.

FIG. 7 shows a remote that may be suitable for use with the device of the present invention. In this embodiment, the remote has icons on the buttons that relate to, for example, different genera of music or videos. In other embodiments, the remote may have conventional numbers of letters for inputting data (similar, for example, to the key pad of a telephone or with each letter, number or symbol having a separate key).

What is claimed is:

1. A method of audio/video playback, storage and organization in a motorized vehicle, comprising:
a. providing a device designed to be installed in the pre-sized radio receptacle of the motor vehicle, said device comprising a receiver for FM and AM radio signals, a CD/DVD player/recorder, optionally, one or more of a cassette tape player or minidisk player, an input for digital audio and video files, an LCD screen for visualizing video and visualizing audio/video file data and a means for storage of electronic data;
b. wherein said means for the storage for electronic data can store digital audio and/or video data from one or more of the audio/video input sources including the FM radio signals, the AM radio signals, the CD/DVD player, the input for digital audio and video files and the optional cassette tape player or minidisk player, if present, and wherein said means for the storage of electronic data can record one form of audio and/or video data while acoustically and/or visually playing the same form or another form of audio and/or video data simultaneously or sequentially and wherein said audio or video can be played back at a time the user desires and wherein said means for one or more of storage of FM radio signals or AM radio signals includes a live-pause feature to selectively prevent portions of a broadcast to be selectively chosen for not being stored;
c. wherein said recorded or stored data is organized into a file system and wherein said file system can be further organized by a user wherein said organization can be by one or more of file size, file type, date of storage, date of original file generation, genera of audio or video file style and wherein said data can be manipulated by said user;
d. wherein said data organization and manipulation can be visualized on said LCD screen in real-time as user organizes and manipulates said electronic data; and
e. wherein said device incorporates a means for generating a user generated personal greeting to be displayed on said LCD screen or played on said device upon turning said device on.

2. The method of claim 1, wherein said LCD screen incorporates a touch-sensitive display.

3. The method of claim 1, wherein audio or video files can be uploaded to an external device.

4. The method of claim 1, wherein said device can be preprogrammed to record signals from one or more of said FM or AM radio signals as a pre-determined time.

5. The method of claim 1, wherein said LCD screen is selected from one or more of an integral display on the face of the device, a flip-down panel mounted on the face of the device or a panel that is pulled out from the device and folded down.

6. The method of claim 5, wherein one or more of said flip-down or pull out and fold-down screen is adjustable as to the angle at which the screen is positioned in relation to the front of the device.

7. The method of claim 1, wherein information about said files stored within said device is provided within said files.

8. The method of claim 1, wherein information about said files stored within said device is provided by the user.

9. The method of claim 8, wherein information provided by said user is delivered to said device by a wireless input device.

10. The method of claim 1, wherein said input source for said device is a camera phone, video camera or other digital input device known in the art.

11. The method of claim 1, wherein the device is also compatible with a non-vehicle-based system such that the device may be removed from the vehicle-based system and inserted into the non-vehicle-based system and retain full functionality.

12. The method of claim 1, wherein said device additionally is internet compatible.
